(19) United States
(12) Patent Application Publication
(10) Pub. No.: US 2008/0086425 A1
(43) Pub. Date: Apr. 10, 2008

(54) METHOD FOR ORDERING ELECTRONIC TRANSACTIONS TO AN INSTITUTION

(75) Inventors: Wilson Vicente Ruggiero, Sao Paulo - SP (BR); Armin Werner Mittelsdorf, Sao Paulo - SP (BR); Ricardo Komatsu De Almeida, Sao Paulo - SP (BR); Leon Achjian, Sao Paulo - SP (BR)

Correspondence Address: DARBY & DARBY P.C., P.O. BOX 770, Church Street Station, New York, NY, 10008-0770, US

(73) Assignee: SCOPUS TECNOLOGIA LTDA., Sao Paulo - SP (BR)

(21) Appl. No.: 11/761,422

(22) Filed: Jun. 12, 2007

(30) Foreign Application Priority Data
Oct. 10, 2006 (BR) PI0605830-2

(51) Int. Cl. H04L 9/00

(52) U.S. Cl. 705/67

(57) ABSTRACT

The method of the invention allows a user to authorize and sign electronic transactions using token programs, even though the software used to effect said transactions is executed in the same terminal device that executes the token program, as it occurs in mobile telephones. A user utilizes an access application or browser to submit electronic transactions, through a terminal device, to an application of an institution, not executing them immediately, but leaving them as pending transactions. Subsequently, the user activates the token program, which consults in the pending transactions in a device in the server of the institution. The user reads the description of each transaction, approving or not the transactions, which are transmitted in or back to the application of the institution with the due authorization or signature, using a secret to be interpreted by this application. Only the transactions correctly authorized/signed are executed by the application of the institution.

### FIELD OF THE INVENTION

The present invention refers to a method that allows a user of an institution, such as a financial institution having restricted or protected access to operations, to authorize and sign electronic transactions utilizing tokens, devices or equivalent programs for authentication or electronic signature, even though the software utilized to effect the electronic transactions is executed in the same device that executes the token program. The method proposed herein is particularly adequate when the terminal device, to be operated by the user of the institution and utilized to execute the applications, does not have the capacity to simultaneously execute both the applications involved.

### PRIOR ART

The proliferation of Trojan horses, viruses, spying equipment installed in automatic teller machines (ATM), etc., which are utilized by fraudsters to intercept passwords to access protected institutions, such as the financial institutions, created the need for new methods to guarantee a correct and reliable identification (authentication) of the users of the institution.

In one end of the range of solutions, there are found the physical tokens and the biometric systems that have a high cost to be adopted in a large scale. The physical tokens, initially utilized for generating OTP (One-Time Passwords, i.e., passwords that are used only once), have been receiving more and more resources, such as generation of passwords by event, by time or challenge-answer, in addition to signature of transaction. Token programs implemented in dedicated hardware have high manufacturing and distribution cost. On the other hand, there are tokens implemented in software which can run in several platforms or devices, such as mobile telephones and PDAs.

Applications with more safety requirements may need something more reliable than a simple authentication of the user, in order to authorize the execution of a transaction, since there are interception attacks which allow an attacker to obtain and use an OTP (one time password). In these cases, the operation of signing transactions utilizing tokens is highly convenient, as the user visualizes the information that describes the transaction he is authorizing and signs it digitally.

In an ordinary scenario, upon accessing, for example, an application of Internet banking, a password (OTP) generated by a token program may be requested. For each new authentication, a different password is given, preventing an attacker, which intercepts the passwords, from re-utilizing them. In the same fashion as the initial authentication, for each electronic transaction effected, the Internet banking system can request a new password generated by the token program. A user that utilizes a personal computer and a token will be able to carry out these browse operations in the Internet banking system and utilize the token without difficulties. This usually happens due to two possible scenarios. In the first scenario, the browser of access to the Internet banking runs in a computer and the token is in a separate device. While browsing in the Internet banking, to each request to operate the token program, the user activates his token program to carry out the requested operation, such as generating a password or signing a transaction. In the second scenario, the personal computer runs both the browser and the token software. Each time the Internet banking system requests a token operation, the user triggers the token program or switches (alternates) the task for the token program in case it is already running, without ending the Internet banking session. After carrying out the token operation, the user switches the task again, returning to the browser and provides the data supplied by the token program. In brief, in the first scenario, there is independence of devices and, in the second scenario, there is the capacity of switching tasks in the same device without finishing said tasks. One scenario which, in many cases, does not have the characteristics of independence of devices and the capacity of switching tasks described above, is the use of mobile telephone appliances to access a mobile banking (banking for mobile devices) by using a software token which runs in the same appliance. Since it is only one device, the independence of devices is naturally inexistent. The capacity of simultaneously running two applications, such as a browser and a token program, or simply token, is not found in most of the current appliances. Accordingly, it is not possible to switch between these applications without finishing the one that is being executed.

A user who wishes to authenticate himself in the system accessed by the browser, has to memorize a password generated by the token program, finish the application of the token, activate the browser and supply this password for authentication. However, the application accessed by the browser cannot request other operation of the token without finishing the access with the browser, because the user is compelled to finish the current application to subsequently activate the token program. This limitation makes the use of the token program extremely inconvenient in devices with these characteristics. In the few devices in which switching is permitted, the operation is not practical, as it requires the user to press several knobs, which allows the occurrence of errors in the process.

### SUMMARY OF THE INVENTION

As a function of the limitations mentioned above and found in several devices, it is an object of the present invention to provide a method which allows the user to submit, authorize and/or sign electronic transactions, with a protected institution, by using a terminal device that is capable to execute, not simultaneously, an application, through which the user submits the transactions to an interaction system of the institution, and a token program to carry out the authorization and signature operations.

This can be executed by using a new type of token program with special characteristics of authorization and signature of transactions. Moreover, it is necessary to create or modify applications so that they do not run in the traditional mode for executing the transactions. Traditional applications usually accept transactions to be executed upon a user authentication or signature effected soon after the specification of the transaction. This means that the application must be active from the instant in which the user specifies which transaction he wants to make until the instant in which the system releases the transaction to be executed. This release occurs soon after the provision of the authentication or signature operation effected by the token program.

In this invention, the applications adopt a new approach, leaving the transactions pending, since they will be conducted in a step subsequent to their specification and submission. It is in these other steps that the token program will be activated to authorize the transactions and permit them to be executed. In a two-step scenario, when the user activates the token program, this is connected to the institution server, checking whether there are pending transactions. Each pending transaction is presented to the user, who can authorize or unauthorize it. The result of this authorization is returned to the institution server, which executes or not each transaction, as selected by the user.

In the present solution, the institution is provided with a determined application and a server device capable to execute it when activated, through a communication channel, from at least one terminal device operated by a respective user of the institution to execute, not simultaneously, an access application and a token program.

According to the invention, the method comprises the steps of:
electronically accessing the application in the server device of the institution, from the access application of a terminal device of the user and through the communication channel;
submitting, to the application of the server device of the institution, from the access application of the terminal device and through the communication channel, an instruction for executing at least one electronic transaction;
activating the token program in the terminal device of the user for one of the modes “authorization” and “signature” of transactions;
receiving, in the token program of the terminal device and through a respective communication channel, an instruction for executing the still pending electronic transaction in the application of the institution;
activating the token program to define one of the instructions of “authorization”, “non-authorization” and “signature” of the instructed transaction; and
transmitting, to the application of the server device of the institution, from the token program of the terminal device of the user and through the respective communication channel, an instruction representative of one of the conditions of “authorization”, “non-authorization” and “signature” of the electronic transaction instructed to the institution;

### BRIEF DESCRIPTION OF THE DRAWINGS

The invention will be described below, with reference to the enclosed drawings, given by way of example of an embodiment of the invention and in which:

FIG. 1 represents a schematic diagram of the elements which compose the invention, illustrating the interaction between said elements; and

FIG. 2 represents a schematic diagram of the applications which compose the invention, illustrating details of communication therebetween, and transaction processing phases.

### DESCRIPTION OF THE INVENTION

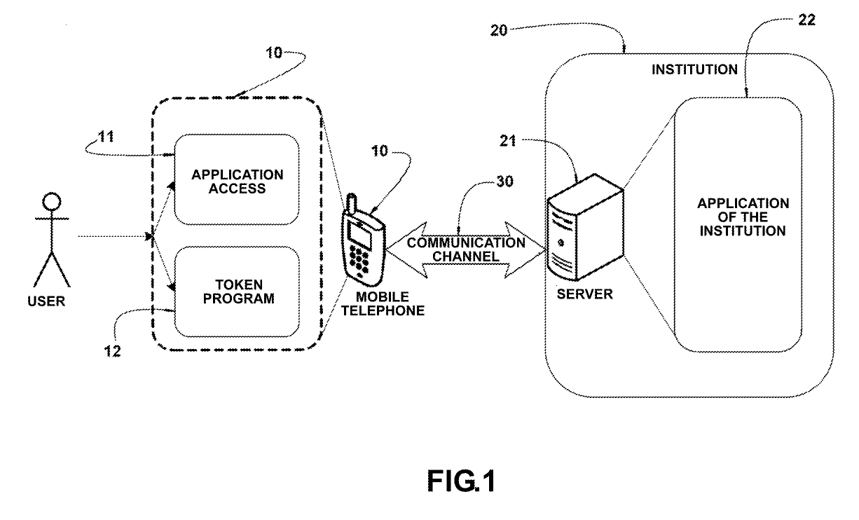

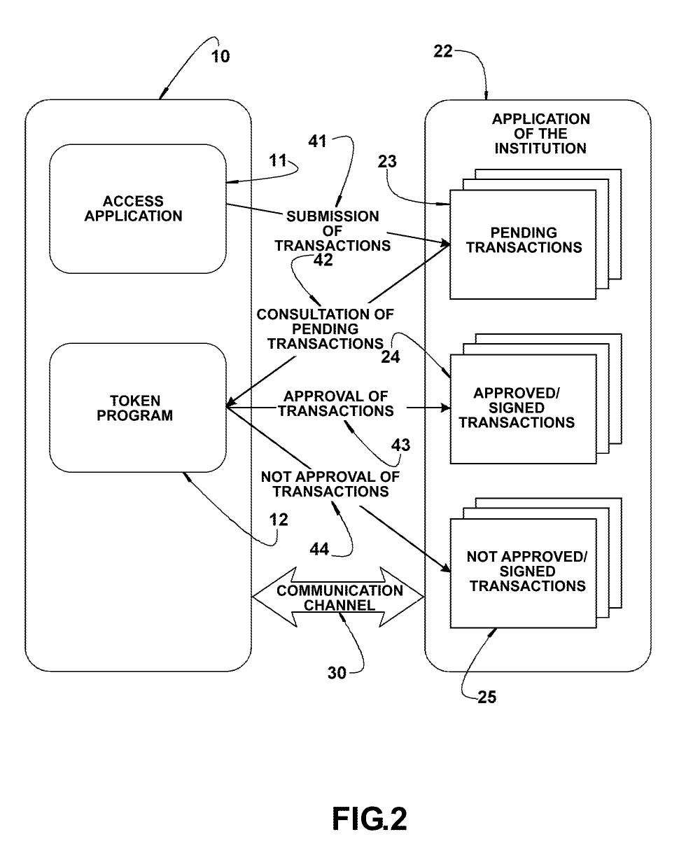

As it can be noted in FIG. 1, the present method is particularly adequate for the interaction between the user utilizing a terminal device 10, such as a mobile telephone, and an institution 20 provided with a server device 21, in order to carry out electronic transactions which need authorization, authentication or signature. The terminal device 10, in the form of a mobile telephone, highly evidences the advantages of the present method. In the embodiment of FIG. 1, it can be noted that, in the terminal device 10, an access application 11 of a user is executed. More specifically, the terminal device 10 executes an access application or browser 11, which allows accessing an application 22 of the institution 20, described ahead, and a token program 12. Due to the limitations of many terminal devices, two different applications cannot be simultaneously executed, which makes unfeasible to execute the token program 12 simultaneously with the access application or browser 11. The application 22 of the institution 20 is executed in a server device 21 and communicates with the mobile telephone through any adequate communication channel 30, such as, for example, the operator network connected to the Internet. The application 22 of the institution 20 allows carrying out electronic transactions which need authentication, authorization or signature by the user of this application. In order to overcome the limitation of simultaneously executing the applications in the terminal device 10, the user that desires to make electronic transactions which need authentication, authorization or signature, utilizes the method object of this invention, operating in two phases. In the first phase is effected the submission of transactions and, in the second, the consultation and authorization/signature of transactions. These phases become more evident in FIG. 2, which present the exchange of information among the applications involved.

In the first phase, the user activates the access application or browser 11, which allows him to register transactions that he desires to effect in the application 22 of the institution 20. These transactions are registered in the institution 20 by the application 22 and marked as pending transactions 23. A pending transaction 23 is a transaction that has been registered, but whose effect has not been executed, depending on a subsequent action. More precisely, the transactions are executed when duly authorized by the user in 43.

An example would be of a user who desires to carry out an operation to transfer money from his current account to another account. In the first phase, he accesses the access application 11 and specifies the destination account and the respective value to be transferred. The access application 11 submits this transaction, in 41, to the application 22 of the institution 20, which does not execute the monetary transfer and leaves it as a pending transaction 23.

In the second phase, the user activates the token program 12, which communicates with the application 22 of the institution 20 and consults, in 42, the pending transactions 23. The user visualizes each of the transactions and opts, in 43 (or 44), for authorizing/signing (or not authorizing) each of the transactions. The token program 12 then takes the text that describes the transaction, links an information that indicates whether the user has authorized or not the execution of the transaction and carries out cryptographic operations, generating a data block transformed by secrets of the user, such as symmetrical or assymmetrical keys, and which can be verified by the application 22 of the institution 20. Depending on the cryptographic operation carried out and the secrets used, this operation can consist of a simple authorization or a signature of transaction.

Each resulting data block is transmitted to the application of the institution, which verifies it. The authorized/signed transactions 24 are executed. The not-authorized/not-signed transactions 25 are registered with the due non-authorization.

It should be understood that the access application 11 and the token program 12 can be installed and executed, generally by the same user, in the same terminal device, such as a mobile telephone, or in respective different terminal devices 10, to be executed by the same user or by different users, in different moments.

In determined situations, it is desirable, for example, that the instruction of authorization, non-authorization or signature be transmitted to the institution 20 after a certain time has elapsed, which can be limited by the institution 20, counting upon completion of the previous step. The maximum wait time period between the beginning of the step of transmitting, to the institution, the instruction defined in the token program and the completion of the previous step, is defined by the institution.

1. Method for ordering electronic transactions to an institution with restricted access to operations and provided with a determined application and a server device that is capable to execute it when activated, through a communication channel, from at least one terminal device operated by a respective user of the institution, in order to execute, not simultaneously, an access application and a token program, comprising the steps of:
electronically accessing the application in the server device of the institution, from the access application of a terminal device of the user and through the communication channel;
submitting, to the application of the server device of the institution, from the access application of the terminal device and through the communication channel, an instruction for executing at least one electronic transaction;
activating the token program in the terminal device of the user, for one of the modes “authorization” and “signature” of transactions;
receiving, in the token program, of the terminal device and through a respective communication channel, an instruction for executing the still pending electronic transaction in the application of the institution;
activating the token program to define one of the instructions of “authorization”, “non-authorization” and “signature” of the instructed transaction; and
transmitting, to the application of the server device of the institution, from the token program of the terminal device of the user and through the respective communication channel, an instruction representative of one of the conditions of “authorization”, “non-authorization” and “signature” of the electronic transaction instructed to the institution.

2. Method, as set forth in claim 1, wherein the access application and the token program are installed and executed in the same terminal device.

3. Method, as set forth in claim 2, wherein the terminal device is a mobile telephone.

4. Method, as set forth in claim 2, wherein the access application and the token program are executed by the same user.

5. Method, as set forth in claim 1, wherein the access application and the token program are installed and executed in respective independent terminal devices.

6. Method, as set forth in claim 4, wherein the access application and the token program are executed by different users.

7. Method, as set forth in claim 1, wherein at least one of the steps of activating the token program and of transmitting, to the institution, the instruction defined in the token program, is effected after a certain time has elapsed in relation to the completion of the previous step.

8. Method, as set forth in claim 7, wherein the maximum wait time period between the beginning of the step of transmitting, to the institution, the instruction defined in the token program and the completion of the previous step, is defined by the institution.
